(19) United States
(12) Patent Application Publication
(10) Pub. No.: US 2025/0260953 A1
(43) Pub. Date: Aug. 14, 2025

(54) DUAL AUDIO MODE RADIO

(71) Applicant: Advanced Wireless Communications, Lakeville, MN (US)

(72) Inventors: Kenneth James Coons, Lakeville, MN (US); Bernard Frederick Brondum, III, Saint Paul, MN (US)

(21) Appl. No.: 19/053,637

(22) Filed: Feb. 14, 2025

Related U.S. Application Data
(60) Provisional application No. 63/553,364, filed on Feb. 14, 2024.

(51) Int. Cl. H04W 4/10; G06F 3/16; G10L 17/02; G10L 17/22; H04M 1/72409; H04R 1/10; H04W 4/80

(52) U.S. Cl. CPC H04W 4/10; G06F 3/165; G10L 17/02; G10L 17/22; H04M 1/724097; H04R 1/1041; H04W 4/80; H04R 2420/07

(57) ABSTRACT

The disclosure relates to dual audio communication system designed for use with two-way radios, including Bluetooth-enabled two-way radios. The system enhances the functionality of traditional PTT systems by allowing users to communicate effectively without the need to be physically near the radio or to wear a Bluetooth headset. The subject matter includes methods for programming the Bluetooth-enabled radio to pair with a Bluetooth headset and/or a remote Bluetooth PTT button and provide dual audio play using the radio speaker and the headset, or other speakers. It allows for the simultaneous playback of audio through both the radio's speaker and the Bluetooth headset, ensuring that users can hear incoming communications regardless of their proximity to the radio or whether they are wearing the headset. The system provides flexibility in how PTT communications are initiated and received, catering to various user environments and scenarios, such as operating a vehicle or wearing Bluetooth-enabled hearing aids.

### PRIORITY CLAIM

This application claims the benefit of priority to U.S. Provisional Patent Application Ser. No. 63/553,364, filed Feb. 14, 2024, which is incorporated by reference herein in its entirety.

### TECHNICAL FIELD

The present disclosure pertains to methods and apparatus for two-way radios, and in particular for a dual audio mode for two-way radios.

### BACKGROUND

Users of Bluetooth compatible radios may be paired with a Bluetooth headset to conduct two-way communications using transmission features of the radio. As demonstrated by FIG. 1, the Bluetooth headset 110 is paired with a Bluetooth-enabled two-way radio 120. When the radio switch 124 is used transmissions are made by pressing the switch 124 on the radio 120 and microphone audio is picked up from the microphone of the paired Bluetooth headset 110. Examples of two-way radios include walkie talkies with built in microphones and switches. Other radios may employ a separate wired microphone with its own switch. The wearer of the Bluetooth headset may hear audio signals received from the Bluetooth-enabled radio 120 which are played by the Bluetooth headset 110 of the wearer. For example, a retailer may use the radio with a Bluetooth headset for communications. One benefit is the headset is wireless and it is easy to operate and wear. However, there are drawbacks with this approach when the user takes off the Bluetooth headset or in activities where it can be difficult to operate the switch 124 on the Bluetooth-enabled radio 120.

Some systems employ a Bluetooth-enabled button 130 to make it easier for the user to activate radio of the system. In such cases the Bluetooth button 130 and the Bluetooth headset 110 are paired with the Bluetooth-enabled two-way radio 120, as demonstrated by FIG. 2. The user simply activates the switch 124 connected to the radio 120, or the Bluetooth button 130 to initiate microphone audio pick up from the Bluetooth headset 110 for the radio to provide to another receiver (not shown). Audio received by the Bluetooth-enabled radio 120 is played by the Bluetooth headset 110 worn by the user. For example, a snowmobiler wearing a Bluetooth headset may use the Bluetooth-enabled two-way radio by activating a button on the snowmobile. That allows the user to press the button 130 to talk to another person. Audio from the other person is received by the snowmobiler via the Bluetooth headset.

The foregoing examples work reasonably well when the user is wearing a Bluetooth headset during an activity; however, when the user has taken that headset off, the user may not hear audio from the radio played over a headset.

There is a need in the art for improved communications to the user of a Bluetooth-enabled radio which allows the user to hear communications from the radio when the user's headset is removed.

### SUMMARY

The present subject matter pertains to an innovative dual audio system that enhances the functionality and user convenience of two-way radios, particularly in scenarios where the user uses a wireless headset, but allows the user to continue hearing communications received by the radio even when the user may have removed that headset temporarily during an activity.

Some of the benefits of the present subject matter include one or more of:

Dual Audio Playback: The Bluetooth-enabled radio is programmed to play audio through both the radio's speaker and the Bluetooth headset simultaneously. This allows users to hear incoming communications whether they are wearing the headset or not, ensuring they do not miss calls or messages.

Flexible Transmission Options: Users can transmit audio by activating a push-to-talk (PTT) button on either a separate Bluetooth device or directly on the radio. The system is designed to pick up the user's voice through the Bluetooth headset's microphone or the radio's microphone, depending on the radio's configuration and the situation.

Enhanced Accessibility: For users without a Bluetooth headset, the system allows for the use of a remote Bluetooth PTT button to communicate. The audio is captured by the radio's microphone, and the user can hear responses through the radio's speaker, which is particularly useful for users in motion or engaged in activities that preclude wearing a headset.

Specialized Use Cases: In certain embodiments, the system is tailored for users with Bluetooth-enabled hearing aids, or other Bluetooth-enabled speaker. The radio is configured to transmit audio only through the hearing aids (or other Bluetooth-enabled speaker) when in PTT mode, providing clear audio without broadcasting it through the radio's speaker. In such applications the radio microphone may be used to capture audio from a user.

The present subject matter addresses the limitations of existing radio systems by providing a more versatile and user-friendly communication solution for individuals using Bluetooth-enabled radios in various environments and situations.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure.

FIG. 1 is a diagram illustrating a conventional setup where a Bluetooth headset is paired with a Bluetooth-enabled two-way radio, and communications are conducted using the radio.

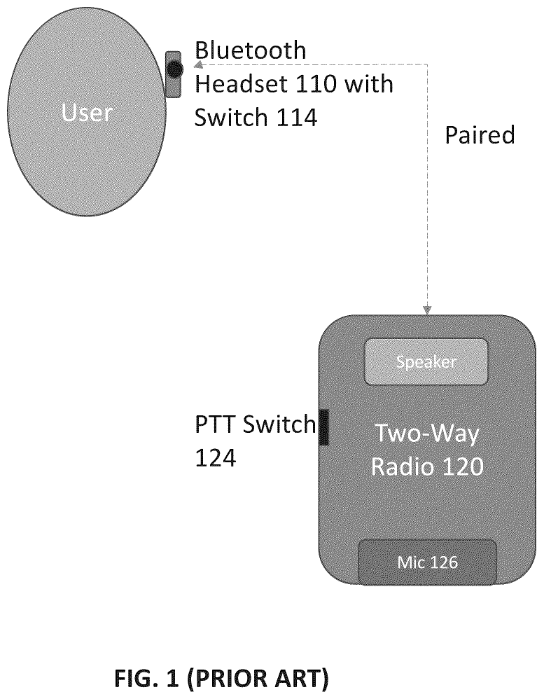

FIG. 2 is a diagram showing another conventional system where a Bluetooth-enabled button and a Bluetooth headset are paired with a Bluetooth-enabled two-way radio, allowing for activation of radio.

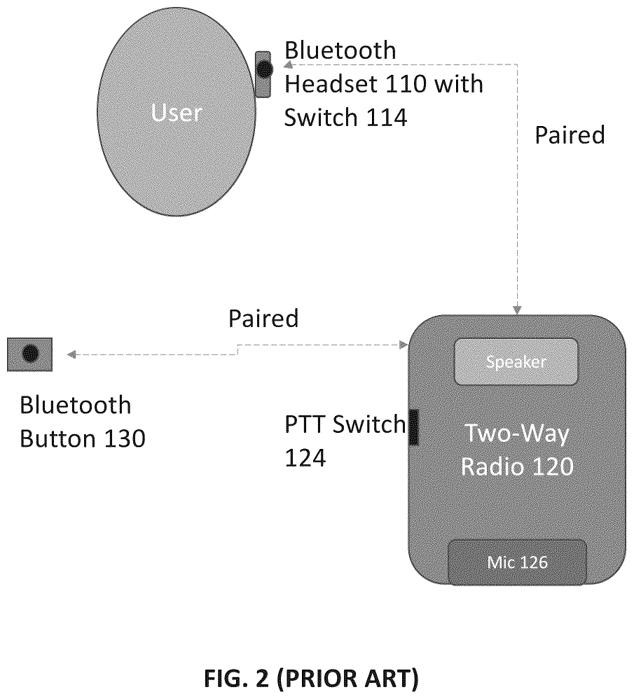

FIG. 3 is a diagram of a wireless communication system, where the two-way radio is programmed to play sound through both the radio's speaker and the wireless headset simultaneously for push-to-talk communications, according to one embodiment of the present subject matter.

FIG. 4 is a diagram of an embodiment where a separate Bluetooth PTT button is paired with a Bluetooth-enabled two-way radio, and the user is not using a Bluetooth headset, with audio being picked up by the radio's microphone, according to one embodiment of the present subject matter.

FIG. 5 is a diagram of an embodiment useful for users with Bluetooth-enabled hearing aids, where the PTT switch on the radio is used for transmitting only, and audio received by the radio is sent only to the Bluetooth headset or hearing aids, with the radio speaker muted, according to one embodiment of the present subject matter.

FIG. 6 is a block diagram of a computing device in the form of a computing system within which a set of instructions may be executed for causing the machine to perform any one or more of the methodologies discussed herein.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The scope of the present invention is defined by the appended claims, along with the full scope of legal equivalents to which such claims are entitled.

Users of Bluetooth-enabled radios that have paired Bluetooth headsets can overcome the difficulties associated with being away from a paired Bluetooth-enabled headset. In one embodiment, the Bluetooth-enabled radio is programmed to play audio simultaneously over the radio's speaker and over a wireless (for example, Bluetooth) headset. This feature allows a user to hear audio through the headset when worn and to hear the audio from the radio when the headset is not being worn. Although the present application refers to Bluetooth and Bluetooth-enabled devices, it is understood that other wireless standards may be used without departing from the scope of the present subject matter.

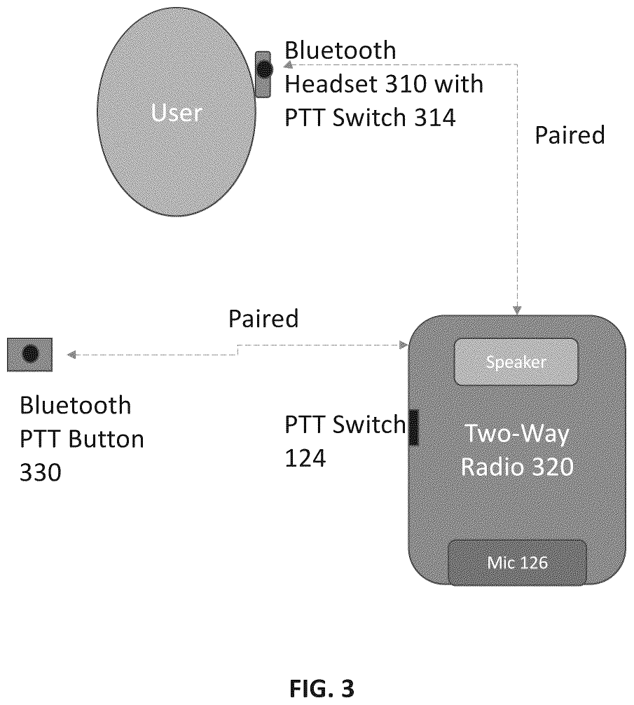

FIG. 3 shows an example of a wireless communication system according to one embodiment of the present subject matter. The two-way radio 320 is programmed to play sound using the speaker of the two-way radio simultaneously with sound played by the Bluetooth headset 310. This mode is a dual audio mode, which the radio is programmed to support. The radio may be instructed to enter this dual audio mode by an instruction by the user. For example, the instruction may be provided by one or more of at least the following: operating a control of the radio, by operation of a software user interface of the radio, by a remote instruction to the radio (e.g., packet communication or other communication). The radio is programmed to provide dual audio upon these instructions, or by other inputs or conditions, such as voice recognition or detection of a paired Bluetooth-enabled device. To transmit, the wearer of the Bluetooth headset 310 may activate push-to-talk via a separately paired Bluetooth button 330 or via a push-to-talk switch 124 on the Bluetooth-enabled two-way radio 320. In the case where a Bluetooth button 330 is employed, audio is picked up from the microphone of the Bluetooth headset 310. In the case where a push-to-talk switch 124 on a microphone of the Bluetooth-enabled radio 320 is employed, microphone audio is picked up from the microphone 126 of the radio. To receive audio the system will play the same audio from the speaker of the Bluetooth-enabled radio 320, and the Bluetooth headset 310, simultaneously.

For example, a snowmobiler using this system will be able to hear audio from the radio, and his or her Bluetooth headset in their helmet. They can activate the Bluetooth headset microphone from a separate Bluetooth push-to-talk button to allow them to communicate while in motion on their snowmobile. If they stop and takeoff their helmet, they will not miss any calls, because they will hear audio from the radio that is being played simultaneously with the audio to the headset. In such case, they can activate the button on the radio to use the microphone on the radio. In various embodiments, the Bluetooth headset 310 may also be used to perform push-to-talk functions using PTT switch 314 in conjunction with two-way Bluetooth-enabled radio 320. To facilitate the PTT function of the Bluetooth headset 310, the headset and/or the radio may be programmed to allow for PTT communications while the switch 314 on the headset is depressed by the user.

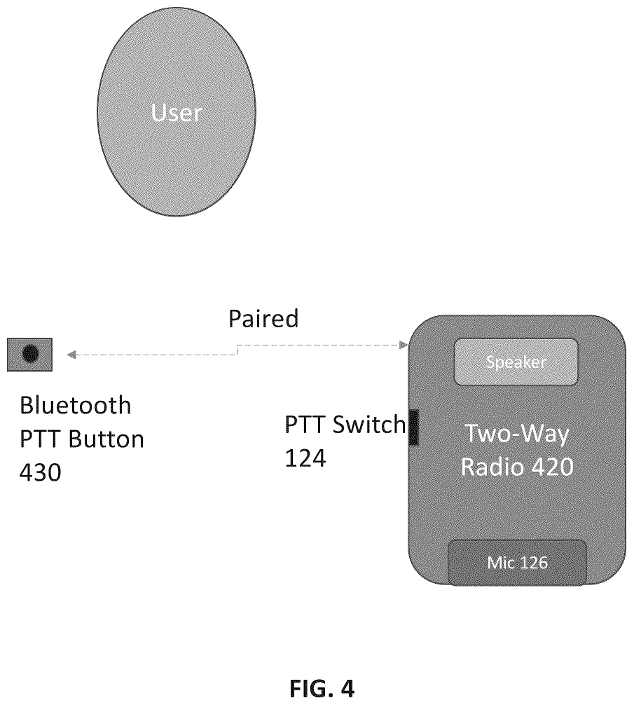

In another embodiment, as demonstrated in FIG. 4, a separate Bluetooth push-to-talk button 430 is paired with a Bluetooth-enabled two-way radio 420, but the user is not using a Bluetooth headset 110 or 310. Transmission is performed by activating the push-to-talk button 430 that is remote from the radio and audio is picked up from the microphone 126 of the radio 420. Alternatively, the push-to-talk switch 124 on the radio 420 is activated by the user and microphone audio is picked up from the radio microphone 126. Audio is played over the local speaker of the radio 420.

For example, using the system of this embodiment, a snowmobiler may use a radio that is attached to their backpack. While they are stopped, they could activate the radio push-to-talk using the remote Bluetooth push-to-talk switch on the handlebars of the snowmobile. This embodiment is easier to operate and safer because the user need not remove the radio or the backpack to communicate with others using the Bluetooth-enabled radio.

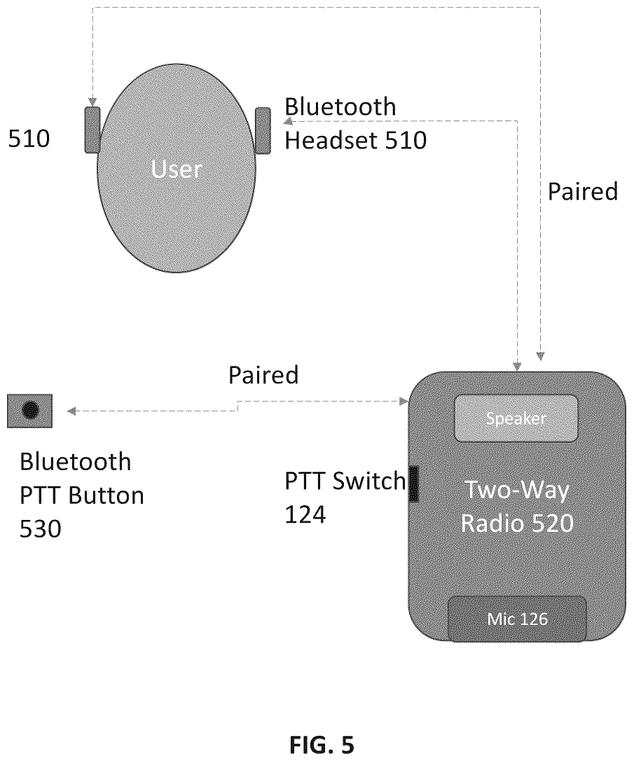

In another embodiment, as demonstrated by FIG. 5, the system is programmed so that the push-to-talk switch 124 of the Bluetooth-enabled two-way radio 520 is used for transmitting only. Audio that is received by the radio 520 from another radio (not shown) is sent to at least one Bluetooth headset 510 only and the radio 520 speaker is muted. It is noted that the diagram of FIG. 5 shows two Bluetooth-enabled headsets 510; however, it is understood that the present subject matter may be used with only one Bluetooth-enabled headset 510. In transmit mode the user can activate the radio push-to-talk switch 124 and the user's speech is picked up from the radio microphone. Thus, audio is played over one or both of the Bluetooth headsets only. This embodiment is useful in the case where a person pairs a Bluetooth-enabled radio with one or more Bluetooth-enabled hearing aids. In such applications, each Bluetooth-enabled hearing aid may be a Bluetooth-enabled headset. This application allows the user to use push-to-talk via the push-to-talk switch 124 of the radio 520 and to hear the audio clearly over one or more Bluetooth-enabled hearing aids. This approach is also useful in the case of hearing aids that do not have a Bluetooth microphone function enabled. Other applications are possible, and the examples given herein are not limiting. For example, in various embodiments, a push-to-talk button 530 may be used to initiate a communication. In various embodiments, the user may select audio play to one or more Bluetooth headsets 510 (or hearing aids) and may select that audio be played over the speaker of the two-way Bluetooth-enabled radio 520. In various embodiments, a voice activation circuit is used to detect the wearer's voice, and thereby trigger a push-to-talk event when the wearer's voice is detected. Such circuits include voice operated (Vox) circuits and may include voice recognition algorithms and software. Other circuits and combinations and applications are possible without departing from the scope of the present subject matter.

In various embodiments, a sensor, indicating that the headset is being worn, is used to make determination of where to send the audio. For example, in embodiments, where audio is being played from the radio itself, if a sensor indicates that the headset is not worn, it may be beneficial to turn off sound played to the headset to preserve battery life.

In various embodiments, multiple Bluetooth headsets may be paired to provide a broadcast function, so that one speaker may be able to speak to a plurality of wearers of Bluetooth headsets. Additional broadcast modes may be employed without departing from the scope of the present subject matter.

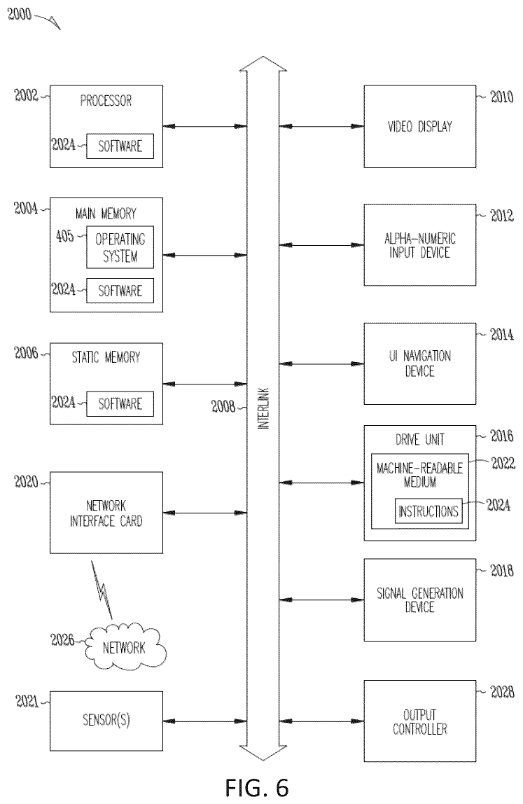

FIG. 6 is a block diagram of a digital device in the example form of a computing system within which a set of instructions may be executed, for causing the radio, headset, or any connected digital hardware to perform any one or more of the methodologies discussed herein. For example, a radio or headset could include one or more of the aspects or components of a computing system in various combinations.

These different components can be located on a single device, multiple devices in one location, or multiple objects in various locations. A network may be used to interconnect any two or more of these modules. In the case of remote devices, the network may be a local area network (LAN), the INTERNET, a personal area network, a wireless network, other networks, or any combination of these networks.

FIG. 6 illustrates a block diagram of an example machine 2000 upon which any one or more of the techniques (e.g., methodologies) discussed herein may perform. In alternative embodiments, the machine 2000 may operate as a standalone device or may be connected (e.g., networked) to other machines. In a networked deployment, the machine 2000 may operate in the capacity of a server machine, a client machine, or both in server-client network environments. In an example, the machine 2000 may act as a peer machine in peer-to-peer (P2P) (or other distributed) network environment. The machine 2000 may be in the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 2000 may include a hardware processor 2002 (e.g., a central processing unit (CPU), a graphics processing unit (GPU), a hardware processor core, or any combination thereof), a controller, a microcontroller, a microprocessor, a main memory 2004 and a static memory 2006, some or all of which may communicate with each other via an interlink (e.g., bus) 2008. The machine 2000 may further include a display unit 2010, an alphanumeric input device 2012 (e.g., a keyboard), and a user interface (UI) navigation device 2014 (e.g., a mouse). In an example, the display unit 2010, input device 2012 and UI navigation device 2014 may be a touch screen display. The machine 2000 may additionally include a storage device (e.g., drive unit) 2016, a signal generation device 2018 (e.g., a speaker), a network interface device 2020, and one or more sensors 2021, such as a global positioning system (GPS) sensor, compass, accelerometer, or other sensor. The machine 2000 may include an output controller 2028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 2016 may include a machine readable medium 2022 on which is stored one or more sets of data structures or instructions 2024 (e.g., software) embodying or utilized by any one or more of the techniques or functions described herein. The instructions 2024 may also reside, completely or at least partially, within the main memory 2004, within static memory 2006, or within the hardware processor 2002 during execution thereof by the machine 2000. In an example, one or any combination of the hardware processor 2002, the main memory 2004, the static memory 2006, or the storage device 2016 may constitute machine readable media.

While the machine readable medium 2022 is illustrated as a single medium, the term “machine readable medium” may include a single medium or multiple media (e.g., a centralized or distributed database, and/or associated caches and servers) configured to store the one or more instructions 2024.

The term “machine readable medium” may include any medium that is capable of storing, encoding, or carrying instructions for execution by the machine 2000 and that cause the machine 2000 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media. In some examples, machine readable media may include machine readable media that is not a transitory propagating signal.

The instructions 2024 may further be transmitted or received over a communications network 2026 using a transmission medium via the network interface device 2020. Machine 2000 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include wired and wireless communications, such as Ethernet, Bluetooth, Bluetooth Low Energy, other Personal Area Networks (PANs), LoRa, NFC, Wi-Fi, WiMAX, 3G, 4G, LTE, 5G, the unlicensed 915 MHz Industrial, Scientific, and Medical (ISM) frequency band, Zigbee, among others. Some standards may support mesh networks. The networks include, but are not limited to, a local area network (LAN), a low-power wide-area network (LPWAN), a wide area network (WAN), a packet data network (e.g., the Internet), mobile telephone networks (e.g., cellular networks), Plain Old Telephone (POTS) networks, and wireless data networks, e.g., Institute of Electrical and Electronics Engineers (IEEE) 802.11 family of standards known as Wi-Fi®, IEEE 802.16 family of standards known as WiMax®, NFC, IEEE 802.15.4 family of standards, a Long Term Evolution (LTE) family of standards, a Universal Mobile Telecommunications System (UMTS) family of standards, peer-to-peer (P2P) networks, among others. The NFC circuitry may be embodied as relatively short-range, high frequency wireless communication circuitry and may implement standards such as ECMA-340/ISO/IEC 18092 and/or ECMA-352/ISO/IEC 21481 to communicate with other devices. In an example, the network interface device 2020 may include one or more physical jacks (e.g., Ethernet, coaxial, or phone jacks) or one or more antennas to connect to the communications network 2026. In an example, the network interface device 2020 may include a plurality of antennas to wirelessly communicate using at least one of single-input multiple-output (SIMO), multiple-input multiple-output (MIMO), or multiple-input single-output (MISO) techniques. In some examples, the network interface device 2020 may wirelessly communicate using Multiple User MIMO techniques.

### EXAMPLES

The following listing of examples are only some of the examples possible given the teachings of the present subject matter and are not intended to limit the scope of the present subject matter.

Example 1 is a method for communicating, using a Bluetooth-enabled radio, comprising: programming the Bluetooth-enabled radio (radio) to play audio simultaneously over a speaker of the radio and a Bluetooth-enabled headset paired to the radio in a dual audio mode of operation, the dual audio mode initiated upon an instruction to the radio to conduct dual audio communications.

Example 2 is the method of Example 1, wherein the radio is programmed to conduct PTT transmissions upon activation of a push-to-talk button (PTT button) of the radio or activation of a Bluetooth-enabled push-to-talk button (Bluetooth PTT button) paired with the radio.

Example 3 is the method of Example 2, wherein the Bluetooth PTT button is configured to be worn by a user.

Example 4 is the method of Example 2, wherein the Bluetooth PTT button is configured to be mounted on a vehicle.

Example 5 is the method of Example 1, further comprising: automatically switching audio output off at the Bluetooth-enabled headset when it is not detecting it is being worn.

Example 6 is the method of Example 1, wherein the programming of the radio includes: enabling a voice-activated transmission mode that initiates a PTT session in response to detection of a user's voice.

Example 7 is the method of Example 1, wherein the radio is further programmed to: mute the radio speaker when the Bluetooth-enabled headset is worn by a user, and to unmute the radio speaker when the Bluetooth-enabled headset is removed.

Example 8 is the method of Example 1, wherein the radio is further programmed to transmit to a plurality of Bluetooth-enabled headsets.

Example 9 is the method of Example 6, wherein the programming includes voice recognition.

Example 10 is the method of Example 1, further comprising programming the Bluetooth-enabled headset for a voice operated PTT function.

Example 11 is the method of Example 1, further comprising programming the Bluetooth-enabled headset for a voice operated PTT function using voice recognition.

Example 12 is a communication method for a Bluetooth-enabled radio system, comprising: configuring a Bluetooth-enabled radio (radio) paired with a Bluetooth-enabled headset to simultaneously play received audio signals through both a speaker of the radio and the Bluetooth-enabled headset, regardless of whether the Bluetooth-enabled headset is being worn by a user; and capturing audio for transmission from a microphone, wherein the microphone is part of the Bluetooth-enabled headset when a PTT control on the Bluetooth-enabled headset is activated, or part of the radio when a PTT control on the radio is activated.

Example 13 is the method of Example 12, wherein a separate Bluetooth-enabled remote PTT button is configured to be mounted on a vehicle, and further comprising: capturing audio from a microphone of the Bluetooth-enabled headset or from a microphone of the radio when the Bluetooth-enabled remote PTT button is pressed by a user.

Example 14 is the method of Example 12, further comprising: automatically switching audio output from the Bluetooth-enabled headset to the radio speaker when the Bluetooth-enabled headset is not detected as being worn.

Example 15 is the method of Example 12, wherein the configuring of the radio includes: enabling a voice-activated transmission in response to detection of a user's voice.

Example 16 is the method of Example 12, wherein the radio is further programmed to: mute the radio speaker when the Bluetooth-enabled headset is worn by the user, and to unmute the radio speaker when the Bluetooth-enabled headset is removed.

Example 17 is a method for communicating, using a Bluetooth-enabled radio, comprising: programming the Bluetooth-enabled radio (radio) to provide a dual audio mode to play audio simultaneously over a speaker of the radio and a Bluetooth-enabled headset paired to the radio.

Example 18 is the method of Example 17, wherein the radio is further programmed to provide push-to-talk communications using a Bluetooth-enabled PTT button configured to be worn by a user.

Example 19 is the method of Example 17, wherein the radio is further programmed to provide push-to-talk communications using a Bluetooth-enabled PTT button configured to be mounted on a vehicle.

Example 20 is the method of Example 17, wherein the radio is further programmed to provide push-to-talk communications using a switch on the Bluetooth-enabled headset.

Example 21 is a communication system, including: a wireless-enabled radio having a speaker and a microphone; a wireless-enabled headset with a push-to-talk (PTT) switch paired with the radio; a wireless PTT button paired with the radio; and a processor configured to: play received audio simultaneously through both the speaker of the radio and the wireless-enabled headset; and capture audio for transmission from the microphone of the wireless-enabled headset when either the PTT switch of the headset or the wireless PTT button is activated.

Example 22 is the system of Example 21, wherein the processor is further configured to: detect when the wireless-enabled headset is being worn; and automatically switch audio output off at the wireless-enabled headset when it is not detected as being worn.

Example 23 is the system of Example 21, wherein the processor is further configured to: enable voice-activated transmission mode that initiates PTT communications in response to detection of a user's voice through the microphone of the wireless-enabled headset.

Example 24 is the system of Example 21, wherein: the wireless PTT button is configured to be mounted on a vehicle; and the processor is configured to capture audio from the microphone of the wireless-enabled headset when the vehicle-mounted wireless PTT button is activated.

Example 25 is the system of Example 21, wherein the processor is further configured to: pair with multiple wireless-enabled headsets simultaneously; and broadcast audio to the multiple paired wireless-enabled headsets.

Example 26 is the system of Example 21, wherein: the wireless-enabled radio, wireless-enabled headset, and wireless PTT button are configured to communicate using Bluetooth communications.

Example 27 is at least one machine-readable medium including instructions that, when executed by processing circuitry, cause the processing circuitry to perform operations to implement any of Examples 1-26.

Example 28 is an apparatus comprising means to implement of any of Examples 1-27.

Example 29 is a system to implement of any of Examples 1-20.

Example 30 is a method to implement of any of Examples 21-26.

The foregoing examples are not intended to be an exhaustive or exclusive list of examples and variations of the present subject matter. The above description is intended to be illustrative, and not restrictive. Those of skill in the art will appreciate additional variations of the embodiments that can be used within the scope of the teachings set forth herein. The scope of the invention should be determined with reference to the appended claims, along with the full scope of equivalents to which such claims are entitled.

What is claimed is:

1. A method for communicating using a Bluetooth-enabled radio, comprising:
programming the Bluetooth-enabled radio (radio) to play audio simultaneously over a speaker of the radio and a Bluetooth-enabled headset paired to the radio in a dual audio mode of operation, the dual audio mode initiated upon an instruction to the radio to conduct dual audio communications.

2. The method of claim 1, wherein the radio is programmed to conduct PTT transmissions upon activation of a push-to-talk button (PTT button) of the radio or activation of a Bluetooth-enabled push-to-talk button (Bluetooth PTT button) paired with the radio.

3. The method of claim 2, wherein the Bluetooth PTT button is configured to be worn by a user.

4. The method of claim 2, wherein the Bluetooth PTT button is configured to be mounted on a vehicle.

5. The method of claim 1, further comprising:
automatically switching audio output off at the Bluetooth-enabled headset when it is not detecting it is being worn.

6. The method of claim 1, wherein the programming of the radio includes:
enabling a voice-activated transmission mode that initiates a PTT session in response to detection of a user's voice.

7. The method of claim 1, wherein the radio is further programmed to:
mute the radio speaker when the Bluetooth-enabled headset is worn by a user, and to unmute the radio speaker when the Bluetooth-enabled headset is removed.

8. The method of claim 1, wherein the radio is further programmed to transmit to a plurality of Bluetooth-enabled headsets.

9. The method of claim 6, wherein the programming includes voice recognition.

10. The method of claim 1, further comprising programming the Bluetooth-enabled headset for a voice operated PTT function.

11. The method of claim 1, further comprising programming the Bluetooth-enabled headset for a voice operated PTT function using voice recognition.

12. A communication method for a Bluetooth-enabled radio system, comprising:
configuring a Bluetooth-enabled radio (radio) paired with a Bluetooth-enabled headset to simultaneously play received audio signals through both a speaker of the radio and the Bluetooth-enabled headset, regardless of whether the Bluetooth-enabled headset is being worn by a user; and
capturing audio for transmission from a microphone, wherein the microphone is part of the Bluetooth-enabled headset when a PTT control on the Bluetooth-enabled headset is activated, or part of the radio when a PTT control on the radio is activated.

13. The communication method of claim 12, wherein a separate Bluetooth-enabled remote PTT button is configured to be mounted on a vehicle, and further comprising:
capturing audio from a microphone of the Bluetooth-enabled headset or from a microphone of the radio when the Bluetooth-enabled remote PTT button is pressed by a user.

14. The communication method of claim 12, further comprising:
automatically switching audio output from the Bluetooth-enabled headset to the radio speaker when the Bluetooth-enabled headset is not detected as being worn.

15. The communication method of claim 12, wherein the configuring of the radio includes:
enabling a voice-activated transmission in response to detection of a user's voice.

16. The communication method of claim 12, wherein the radio is further programmed to:
mute the radio speaker when the Bluetooth-enabled headset is worn by the user, and to unmute the radio speaker when the Bluetooth-enabled headset is removed.

17. A method for communicating, using a Bluetooth-enabled radio, comprising:
programming the Bluetooth-enabled radio (radio) to provide a dual audio mode to play audio simultaneously over a speaker of the radio and a Bluetooth-enabled headset paired to the radio.

18. The method of claim 17, wherein the radio is further programmed to provide push-to-talk communications using a Bluetooth-enabled PTT button configured to be worn by a user.

19. The method of claim 17, wherein the radio is further programmed to provide push-to-talk communications using a Bluetooth-enabled PTT button configured to be mounted on a vehicle.

20. The method of claim 17, wherein the radio is further programmed to provide push-to-talk communications using a switch on the Bluetooth-enabled headset.

21. A communication system, comprising:
a wireless-enabled radio having a speaker and a microphone;
a wireless-enabled headset with a push-to-talk (PTT) switch paired with the radio;
a wireless PTT button paired with the radio; and
a processor configured to:
play received audio simultaneously through both the speaker of the radio and the wireless-enabled headset; and
capture audio for transmission from the microphone of the wireless-enabled headset when either the PTT switch of the headset or the wireless PTT button is activated.

22. The system of claim 21, wherein the processor is further configured to:
detect when the wireless-enabled headset is being worn; and
automatically switch audio output off at the wireless-enabled headset when it is not detected as being worn.

23. The system of claim 21, wherein the processor is further configured to:
enable voice-activated transmission mode that initiates PTT communications in response to detection of a user's voice through the microphone of the wireless-enabled headset.

24. The system of claim 21, wherein:
the wireless PTT button is configured to be mounted on a vehicle; and
the processor is configured to capture audio from the microphone of the wireless-enabled headset when the vehicle-mounted wireless PTT button is activated.

25. The system of claim 21, wherein the processor is further configured to:
pair with multiple wireless-enabled headsets simultaneously; and
broadcast audio to the multiple paired wireless-enabled headsets.

26. The system of claim 21, wherein:
the wireless-enabled radio, wireless-enabled headset, and wireless PTT button are configured to communicate using Bluetooth communications.
